(19) United States
(12) Patent Application Publication
(10) Pub. No.: US 2003/0126052 A1
(43) Pub. Date: Jul. 3, 2003

(54) Method and apparatus for establishing real estate investments

(76) Inventors: Jeff J. Rademaekers, Dallas, TX (US); Chris L. Gougler, Coppell, TX (US)

Correspondence Address: BUCKLEY, MASCHOFF, TALWALKAR, & ALLISON, 5 ELM STREET, NEW CANAAN, CT, 06840, US

(21) Appl. No.: 10/314,606

(22) Filed: Dec. 9, 2002

Related U.S. Application Data
(60) Provisional application No. 60/337,909, filed on Dec. 7, 2001.

(51) Int. Cl. G06F 17/60

(52) U.S. Cl. 705/35; 705/38

(57) ABSTRACT

A system, method, apparatus, computer program code and means for establishing a real estate investment are provided which include receiving information identifying a user responsible for a new real estate investment, receiving information identifying the new real estate investment, monitoring the received information identifying the new real estate investment for information triggering a trigger event, and causing the transmission, when the triggering event is detected, of a notification message to a designated recipient.

### RELATED APPLICATIONS

This application hereby claims priority to, and hereby incorporates by reference herein for all purposes, U.S. Provisional Application Serial No. 60/337,909, filed Dec. 7, 2001.

### FIELD

The present invention relates to data processing systems. More particularly, embodiments of the present invention relate to systems used to establish real estate investments.

### BACKGROUND

A typical real estate investment process involves activities by employees, agents, or other representatives in the field who identify potential investments. These representatives often perform early identification and analysis of a large number of potential transactions; many of the potential transactions never mature into actual investments. If a determination is made that a potential transaction is of sufficient potential, information may be submitted to an investor's loan origination group and/or risk analysis group for further review to determine if the investment could be funded. If a further determination is made that the potential transaction is desirable, information about the investment may be written up and formally submitted to the investor's origination, pricing, and underwriting groups for approval and funding.

Currently, this process involves the production of multiple duplicate copies of information, providing many opportunities for errors in data entry as well as inconsistencies in information sent to the various participants. In addition, a potential investment which was undesirable for some reason at one point in time may become desirable later as market conditions change. In such situations, the representatives must regenerate information about the potential transaction and resubmit the information to the various parties involved. This can be time-consuming and again introduces many error opportunities and inefficiencies. It would be desirable to provide a new investment setup approach which reduces these opportunities for error and inefficiency.

### SUMMARY

Embodiments provide a system, method, apparatus, computer program code and means for establishing a real estate investment are which include receiving information identifying a user responsible for a new real estate investment, receiving information identifying the new real estate investment, monitoring the received information identifying the new real estate investment for information triggering a trigger event, and causing the transmission, when the triggering event is detected, of a notification message to a designated recipient. In some embodiments, the information identifying the new real estate investment is transferred to an asset management system upon completion of the new investment. In some embodiments, some or all of the new investment information may be transferred to an asset management system.

### BRIEF DESCRIPTION OF THE DRAWINGS

FIG. 1 is a block diagram of a system consistent with the present invention;

FIG. 2 is a flow diagram illustrating an exemplary new investment creation process according to some embodiments;

FIG. 3 is a flow diagram illustrating further details of a new investment process according to some embodiments; and

FIGS. 4A and 4B are exemplary representations of user interfaces according to some embodiments.

Advantages and features of the invention will become hereinafter apparent, and the nature of the invention may be more clearly understood by reference to the following detailed description of the invention, the appended claims and to the several drawings attached herein.

### DETAILED DESCRIPTION

Applicants have recognized that there is a need for a system, method, apparatus, and computer program code for establishing real estate transactions that overcomes drawbacks of existing systems.

Features and advantages of embodiments of the present invention will be discussed in detail below, by first describing a system overview of some embodiments. Throughout this disclosure, an example system will be used to describe and illustrate features of embodiments of the present invention. The example system involves an entity which enters into real estate transactions. As a particular example, the entity is one which enters into a large number of real estate transactions based on properties around the U.S. or even around the world. For example, at any given point in time, the entity (or its agents) may be evaluating potential opportunities for investment in a diverse number of properties and deals. A number of the potential opportunities are not funded, or do not otherwise mature into actual investments. A number of the potential opportunities are approved for funding and become investments which are managed by the entity. Some potential opportunities may be rejected at one point in time, and then funded at a later point in time (e.g., as a result of changed economic or other conditions). Once the new investment is completed (e.g., funded and with final documentation), an asset management system may be used to manage the investment (e.g., to track rents, payments, etc.).

Applicants have discovered that the tracking, manipulation, and use of information generated during the evaluation and funding processes is subject to errors (e.g., as a result of multiple data entry requirements, the creation of multiple files, and the like) and is generally inefficient and time consuming. The process is further complicated by the nature of the real estate business (e.g., a potential real estate investment may be rejected at one point in time and funded at a later point in time based on changed economic or other conditions).

Applicants have further discovered that embodiments that capture information when a potential deal is first identified (or even when an early contact has been initiated), results in an improved process of approving, originating and underwriting the real estate deal. For example, embodiments substantially reduce or eliminate the need to repeatedly input investment information in approval, origination, and underwriting systems. This reduces errors and increases efficiency. Further, in some embodiments, the new investment information may be utilized to generate automated trigger events during the transaction approval process, thereby ensuring that each of the necessary events in complicated transactions are performed when needed. Further, new investment information may be transferred directly to an asset management system for use in tracking and managing the assets associated with the investment.

### SYSTEM OVERVIEW

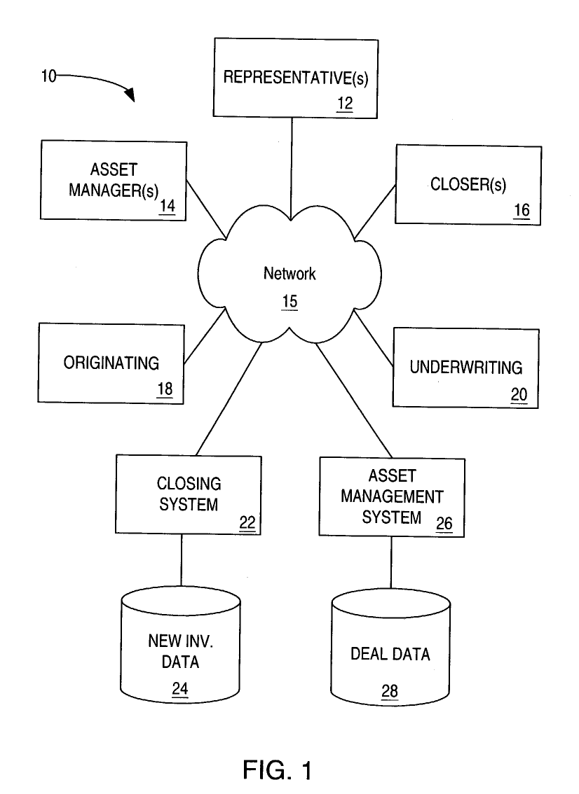

Features of embodiments will now be described by first referring to FIG. 1 which is a system diagram depicting a representative real estate transaction system 10 implementing features of embodiments of the present invention. System 10 includes a number of different entities or devices, each of which are in communication with each other via a network 15. Network 15 may be any of a number of different types, configurations, or combinations of networks (e.g., such as the Internet, an intranet, a WAN, a LAN, wired or wireless networks, etc.) allowing communication among and between devices such as devices operated by or on behalf of the different participants of FIG. 1. Some or all of the devices may be computing devices (e.g., such as personal computers or the like, some or all having processors, memory, display devices, output devices, and data entry devices associated therewith).

As depicted, system 10 includes a closing system 22 which is configured to manage, store, and manipulate information about various new real estate investments that are being processed or entered into by an entity operating the system 10. System 10 may also include an asset management system 26 which is configured to manage, store, and manipulate information about completed investments held (or managed) by an entity operating the system 10.

A real estate investment entity may operate one or more closing systems 22 in order to manage the closing of its new real estate investments. As will be described further herein, closing system 22 may also be configured to receive, manage, store, manipulate, and utilize information associated with potential real estate investments as well as information associated with “new” (i.e., funded or approved for funding) real estate investments of the entity. This information associated with potential and new real estate investments is depicted as being stored at the database identified as new investment data 24.

As will be described further herein, once a closing has been completed (e.g., an investment or deal has been funded and all approvals and documentation associated with the investment or deal have been completed), information may be transferred from closing system 22 to asset management system 26. In this manner, data entry errors are reduced and efficiency is increased (e.g., embodiments reduce the need to repeatedly enter information about an investment at the evaluation stage, at the origination and underwriting stage, and at the deal management stage).

In some embodiments, closing system 22 (as well as asset management system 26) may be configured as a Web-server accessible to one or more user devices operated by or on behalf of the various participants shown in FIG. 1. For example, a closer operating a computing device (e.g., such as a personal computer or the like) may direct a Web browser to interact with closing system 22 using Internet or other protocols. Other configurations may also be utilized (e.g., including direct network connections between the various devices, or the like).

As depicted, system 10 includes one or more representative(s) 12 who interact with closing system 22 (and other devices in system 10) via a network 15. These representative(s) 12 may be employees or agents of a real estate investment entity. For example, a representative interacting with closing sytem 22 may be an agent in a particular geographical region and/or market who is tasked with identifying desirable real estate investment opportunities on behalf of the real estate investment entity. A typical real estate investment entity may work with or employ a large number of agents or representatives who monitor local markets to identify potential investments. Each representative 12 may interact with a number of property owners and other entities to provide an initial evaluation and location of desirable investment opportunities. Each representative 12 may interact with closing system 22 to enter information about potential real estate investment opportunities as will be described further herein.

In the depicted system 10, one or more closer(s) 16 may also be in communication with network 12. For example, each of these closers 16 may be employees or agents of a real estate investment entity which operates closing system 22. Closers 16 may interact with closing system 22 to perform tasks associated with the closing or completion of real estate investments entered into on behalf of the real estate investment entity. For example, each real estate transaction which has been approved for funding may be associated with or assigned to a specific closer 16. The closer will then be responsible for monitoring the transaction as it moves through the real estate investment entity's approval process (e.g., through origination, underwriting, etc.). The closer may also interact with the asset manager associated with the properties of a particular transaction.

One or more asset manager(s) 14 may also be in communication with closing system 22 (as well as asset management system 26). For example, an asset manager may be an individual or entity which is tasked with managing a specific item of property associated with a completed real estate investment entered into by a real estate investment entity. The asset manager may also view (and, in some situations, edit or enter) information associated with a new investment by interacting with closing system 22. The asset manager may view information about a property associated with a completed real estate investment by interacting with asset management system 26 (asset manager 14 may also periodically enter and update property or asset information by interacting with asset management system 22). Embodiments help ensure the accuracy of data (and reduce data entry time and errors) by transferring information from closing system 22 to asset management system 26 upon completion of an investment.

The real estate investment entity which operates system 10 may also utilize one or more individuals or entities which function as an originating group 18 as well as an underwriting group 20 (and which perform the functions of originating and underwriting investments of the real estate investment entity, respectively). Any number of different devices or entities may be provided in system 10. For example, one or more representatives, asset managers, closers, originators, underwriters, asset management systems, and databases may be provided. For convenience, throughout the remainder of this disclosure, each of the entities or devices introduced in FIG. 1 will be referred to in the singular (e.g., although a number of closers 16 may be typically involved in a system 10, a single closer 16 will be referenced).

As will be described, embodiments reduce errors and increase efficiency in the real estate investment process, in part, by capturing potential real estate investment information generated by representative 12, as well as new investment information generated by other participants (e.g., such as representative 12, closer 16, asset manager 14, etc.). Further, once a new investment has been completed, the data associated with the new investment may be transferred directly to an asset management system (such as system 22). Asset management system 22 may be utilized on an on-going basis to manage each investment of the real estate investment entity.

The information about potential investments is entered early in the process (e.g., when the potential investment is simply a potential opportunity that has not yet been evaluated or approved for funding). This potential investment information is transmitted to closing system 22 for storage (e.g, in new investment data 24) and for later use by closing system 22 if the potential investment is approved for funding (e.g., becomes a “new investment”). If the potential investment becomes a new investment, some additional information is likely to be entered (e.g., by the closer assigned to the investment). This new investment information provides specific detailed information about the new investment. In some embodiments, the new investment information uses prior data entered when the potential investment information was originally entered, thereby reducing errors and elimininating the need to enter duplicate sets of data.

In some embodiments, the potential investment information is entered into a first software application (e.g., such as client software which is designed to be used to collect information identifying potential leads, investments or the like), and the new investment information is entered into a second software application. In some embodiments, when a potential investment is approved for funding or otherwise approved to become a new investment, some or all of the information collected in the first software application is transferred to the second software application. In some embodiments, once the new investment is completed (e.g., the deal is funded and documentation completed), some or all of the new investment information is transferred to asset management system 26 for use in managing the assets.

As will be described further below, a wide variety of new investment information may be entered, including information used to establish event triggers and reminders. Some or all of this information may be passed to originating and underwriting systems for approval. In some embodiments, some or all of this information may be passed electronically (e.g, via network 15), thereby further reducing the need for redundant and error-prone data entry.

### PROCESS DESCRIPTION

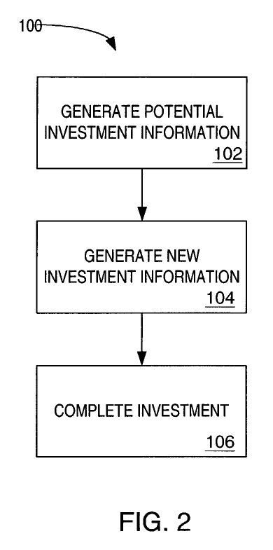

Reference is now made to FIG. 2, where a flow diagram is shown depicting an investment process 100 pursuant to some embodiments. Some or all of the steps of process 100 may be implemented using system 10 of FIG. 1. Investment process 100 begins at 102 where information regarding a potential investment is generated. For example, a potential investment may be identified by a representative 12 or other individual or employee of a real estate investment entity. Processing at 102 may include input of potential investment information into closing system 22 (for example, by allowing the representative to interact with closing system 22 over network 15).

In some embodiments, representative 12 may operate a computing device such as a personal computer, or the like, allowing the representative to electronically input potential investment information. In some embodiments, the representative 12 may operate a device which is configured with client software adapted to perform the functions described herein; in other embodiments the software may be server-based software installed at closing system 22 and accessed by representative 12 over network 15. Other configurations known to those skilled in the art may also be utilized.

A number of different types of information may be input to generate a potential investment opportunity at step 102. For example, a representative 12 may enter information identifying the following items of information: a currency of the potential transaction; a name of the potential deal or transaction; a type of the potential transaction (e.g., CMBS, equity, structured, etc.); an initial funding amount of the potential transaction (including either debt or equity initial amounts); an amortization contract term (if applicable); an interest rate; an interest rate adder; an address (including country, city, and other specifics) of the property(s) associated with the potential investment; the year any structure associated with the potential investment was built; occupancy information; and other information deemed necessary or useful to evaluate a potential real estate investment for funding.

In some embodiments, once the potential real estate investment information is generated at 102, processing may continue to a funding determination (not shown). For example, a funding determination may be made based on the information generated at 102 and based on other information associated with the potential investment (e.g., including risk information generated or collected by an origination or underwriting group).

Funding determinations may be made based on a number of different decisions and processes. For example, underwriters associated with the real estate investment entity may review the potential real estate investment data entered at 102 to determine if the potential investment presents a suitable risk/reward profile. If the potential investment meets the real estate investment entity's investment criteria or otherwise is deemed to be a desirable investment, a funding approval determination is made. If the potential investment does not present a desirable investment opportunity, a decision may be made that the potential investment identified at 102 is not to be funded. If the potential investment is not funded, further potential real estate investment information may be generated at 102. In some embodiments, a decision to not fund a potential real estate investment may be revisited at a later date (e.g., if the potential deal terms change or if economic conditions or investment criteria change).

Processing continues at 104 where, after a funding determination has been made, a new investment is generated. In some embodiments, a new investment may be generated even prior to a full funding decision has been made. In some embodiments, a period of time may pass between the time that a potential investment was generated or identified at 102 and the time that a new investment is generated at 104. By utilizing information entered at 102, the potential for errors in data entry at 104 is reduced. Further, inaccuracies or inconsistencies between the terms of the deal that was approved for funding and the terms of the new investment are reduced by using the same information as was entered at 102. If a potential new investment (generated at 102) is not funded (or otherwise approved for establishment as a new investment), the information nevertheless may be retained by system 10 in case the potential new investment (or a variant thereof) is funded in the future.

Information entered at 104 may include information identifying: overall aspects of the new investment or “deal” (including parties involved in the deal, such as a particular closer, asset manager, etc.); investment information associated with the deal (including details of one or more investments associated with the deal, etc.); property information associated with the deal; participation information (including information identifying the real estate investment entity's scope and terms of participation in the deal); information identifying joint venture terms (if applicable); legal information; allocation information; and marketing or tombstone information associated with the deal. Further details of some of this information will be provided further below.

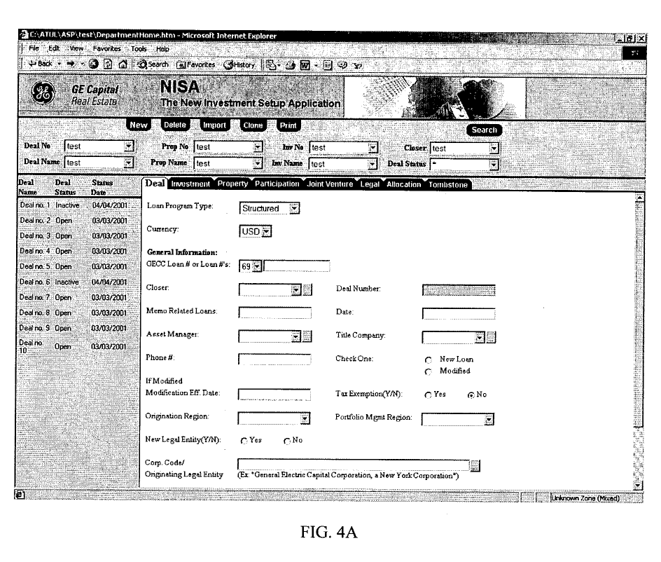

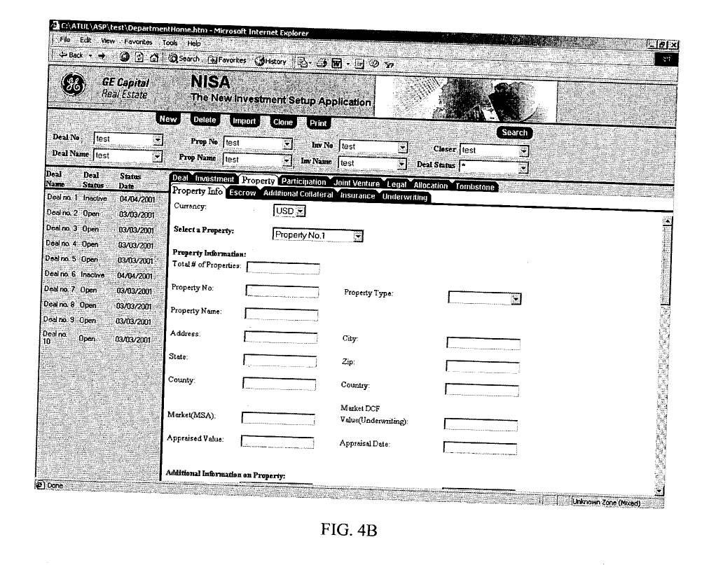

In some embodiments, as will be described further below, some or all of this information (to the extent that it is not automatically retrieved from potential investment data entered at 102) is entered by, for example, a closer 16 assigned to the investment, and interacting with closing system 22 via network 15. In some embodiments, closing system 22 is configured as an Internet server and a closer 16 interacts with the server by directing a Web browser on a computing device to interact with the Internet server. In some embodiments, a series of Web pages are presented to closers to allow them to accurately and efficiently enter information about the new investment. A series of example Web pages or user interfaces are presented as FIGS. 4A-4B (described further below).

Once the necessary information is entered to generate a new investment at 104, processing continues at 106 where the information is used to complete the investment. For example, information regarding the new investment may be passed to an originating group, an underwriting group, or other entities associated with approving and completing an investment entered into by the real estate investment entity. Some or all of this approval and completion process may be controlled by closing system 22. For example, as will be described further below, based on the new investment information generated at 104, closing system 22 may generate triggers or event reminders for various events leading up to the completion of the investment (e.g., such as, for example, funding event reminders, legal event reminders, marketing or promotional reminders, etc.).

These triggers or event reminders may be sent to particular employees or groups in communication with closing system 22 upon the occurance of certain pre-defined triggering events or changes in status of the new investment (e.g., such as the pre-funding of the investment, completion of the investment, establishment of a new legal entity, etc.). In this manner, the completion of the funding, origination, underwriting, and issuance of a particular deal can be coordinated with a number of diverse parties. Upon completion of an investment, information regarding the completed investment is stored at, or accessible to, closing system 22. In some embodiments, some or all of this information is then tranferred to asset management system 22 for use in maintaining or otherwise managing the assets associated with the now-completed investment.

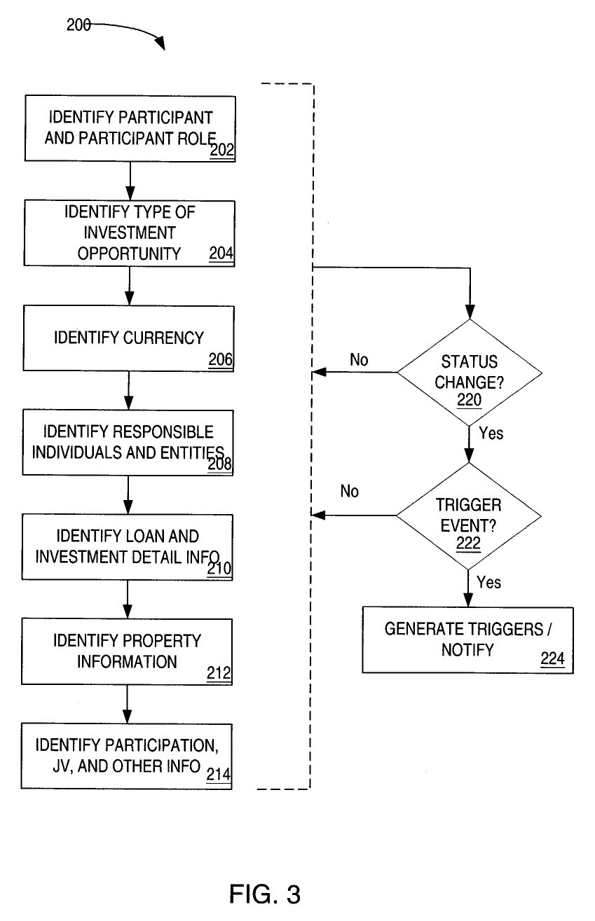

Further details of the generation of new investment information will now be described by reference to FIG. 3, where a further flow diagram is shown which may be implemented using system 10 of FIG. 1. In particular, the flow diagram depicted in FIG. 3 represents details of step 104 of the flow diagram 100 of FIG. 2 (relating to the generation of new investment information). The process 200 of FIG. 3 may be performed sometime after potential investment information has been entered (e.g., after a potential investment has been approved for funding). Process 200 may be initiated, for example, by a closer 104 (FIG. 1) who has been appointed as the person in charge of entering information regarding a potential new investment.

Process 200 begins at 202 where the participant entering information (e.g., the closer or other individual designated to enter the new investment information) is identified (as well as his role). For example, the participant may enter his e-mail address or other identifying information (along with a password or other security information). Once the participant has been identified, the participant's role may be identified (e.g., such as a closer, administrator, asset manager, guest or other participant). This role information may indicate the nature of information that may be entered, amended, or altered by the participant. For example, a participant having the role of “closer” may be allowed to create a new investment, edit, delete, import, copy (or clone), and print all information associated with particular new investments. An asset manager, guest, or other participant, may not have the ability to perform some of these functions. These different roles or privileges may be established by an administrator or other entity responsible for operation of system 10.

Processing continues at 204 where information identifying the type of investment opportunity is entered. For example, the participant may identify the new investment as a structured loan, a commercial mortgage backed security (CMBS), or other type of deal. Selection of the type of new investment may cause different types of data entry screens to be presented to the participant (e.g., a structured loan data entry screen may have details regarding particular loan details, title information, tax data, and other information that would not be presented on a CMBS data entry screen).

Processing continues at 206 where the currency type of the investment is identified (this information may previously have been entered at step 102 of the potential investment data entry associated with the process of FIG. 2, and may simply be confirmed at 206 of the process of FIG. 3). Processing continues at 208 where information identifying responsible individuals and entities is entered. For example, if the deal is a structured loan, information identifying the responsible closer, asset manager, title company, trustee, etc. may be entered. If the deal is a CMBS, information identifying any third parties needing third party reports may be entered. Some of this information may be used to establish trigger or notification events as will be described further below.

Processing continues at 210 where information identifying loan and investment detail information is entered. For example, if the type of investment is a structured loan, information identifying the loan number(s), borrower (including legal name and address), the principal information, billing contact information, etc. may be provided. If the type of investment is a CMBS, information identifying the loan number(s), borrower, the billing company, principal information, indemnity information, and the like may be provided. Further, the participant entering the information may also indicate the status of the loan. For example, if the participant is simply entering the information, he may just save the loan information. If the loan has been pre-funded, the information may be saved and tagged as “pre-funded”. If all of the loan documents and approvals have been processed, the participant may indicate that the loan has been “released”. Thus, embodiments contemplate that a participant (such as a closer responsible for the new investment) may enter loan information and loan status information at several different points in time as the loan is entered, approved, etc.

Once a loan has been “released” or when final terms have been established, the closer (or other participant) may enter final loan terms such as, for example: the amount; the note date; the funded date; the first payment date; etc. As with other information, some or all of the loan and investment details may be “cloned” from other investments. Some or all of the information may be imported from an external source (e.g., from a Microsoft® Excel® spreadsheet or the like). As with other information entered in process 200, some data entered at 210 may be associated with fixed sets of information that are selected from drop down menus (e.g., the real estate investment entity may deal only with a fixed set of pre-approved title companies which are selected from a drop-down menu).

At 212, the participant enters information identifying the property associated with the investment or deal. Each deal can involve multiple properties. Each investment can also relate to multiple properties. Each property can be related to mutiple investments. This information is tracked, in part, by information entered at 212. In some embodiments, a property information screen can be presented to a participant for data entry which includes multiple screens or sub-tabs. In some embodiments, the data entry screens are broken into the following groupings: property information; escrow information; additional collateral; insurance information; and underwriting information. The property information screen includes fields for general information regarding each subject property (e.g., including propety name, type, location, appraisal information, size, etc.). The information entered (and screens presented) may vary depending on the type of investment with which the property is associated (e.g., a different screen appears if the investment is a structured loan than if the investment is a CMBS).

The escrow information screen includes fields related to escrow(s) for the subject property (e.g., including tax escrows, capital replacement escrows, tenant rollover escrows, environmental escrows, and other hold backs). Again, the screens may vary depending on the nature of the investment.

The additional collateral screen includes fields identifying additional collateral items associated with the subject property (e.g., including the party, amount, collateral rules, etc.). The screens and information to be input may vary depending on the type of investment. The insurance information screen includes fields identifying insurance information associated with the subject property (e.g., including the carrier, amounts, policy numbers, effective date, etc.). The underwriting screen contains information about the property economics for the subject property(s), including, for example, occupancy of the property (in percentage); budget cash flow income; budget cash flow expense; replacement reserves; net operating income; total income; letter of credit information; capital expenditures; non-operating income and expenses; entity funding amounts; proforma basis for underwriting; net cash flow; and other related information. Again, the nature of information may vary depending on the nature of the investment (e.g., structured vs. CMBS or the like).

Once the property details have been input, processing may continue at 214 where participation, joint venture and other information may be input. For example, separate input screens may be presented to prompt a closer to input information regarding the total participation of the real estate investment entity. As an example, a participation screen may be invoked from a main data entry screen. The participation screen may include a drop-down box identifying a list of each of the investment(s) associated with a selected deal. Participation information may be entered or viewed for each of the investments. This participation information may include, for example: % of Cash Flow or amount required to reduce accrued balance of loan; % of Cash Flow or amount required as additional income to the loan; % of Cash Flow or amount required to amortize the principal on the loan; % of backend participation kicker or amount required upon sale or payoff of the loan; Minimum % of backend participation kicker or amount required upon sale or payoff of the loan; % of Repayment Fee or repayment amount required upon payment of the loan; whether a participation fee is associated with the investment; a frequency of payment of cash flow to reduce accrual, ie. Monthly, Annually, etc.; and other information defining participation amounts associated with each investment.

If the investment is associated with a joint venture arrangement, a joint venture data entry screen may be presented for editing and viewing. The joint venture data entry screen may include data fields to capture information such as: the joint venture parties; the joint venture percentages and contributions; etc. A legal information screen may also be presented for editing and viewing, and may include, for example, information identifying: the closing attorney or firm; a broker firm; an escrow officer; any fee split amounts or agreed-upon closing arrangements; etc. An allocation data entry screen may also be presented for viewing and editing, and may include, for example, information identifying: a lien position; a cash position; a lien type; an allocation percentage, etc.

Finally, a marketing or “tombstone” screen may also be presented for data entry and viewing. Many real estate deals result in the production of marketing or deal information which is publicly announced at the close of the deal. For example, in some situations, the parties to the deal agree to publish a “tombstone” or deal announcement that is published to announce the completion of the deal (often, these deal announcements are announcements having content agreed to by the parties, having a “tombstone”-like shape). Embodiments allow the entry of information which will be included in the announcement (and, as described further below, also allow the automated generation of a trigger when the deal closes and the announcement can be published). The data entry field may include, for example, a drop-down box allowing the closer to identify whether the deal is one which has been approved for such a promotional announcement. If the deal is one which has been approved for public announcement, trigger events will be established to notify appropriate participants once the announcement is ready for publication (e.g., using selected data and information previously entered about the deal, such as the parties, the property, and the amount).

Other data entry screens and information may also be entered regarding new investments using embodiments of the present invention. For example, in some embodiments, separate data entry screens may be provided to enter specific contact information regarding the transaction. Other data entry screens may be provided to enter company information identifying companies associated with the transaction. In some embodiments, a “set limits” screen may be provided (which may only be accessible to participants having administrator access) to establish upper and lower limits determined by the entity from time to time (e.g., limits may be established regarding interest rates, the amortization term, the contract term, dates, and late charge rates). In this manner, new investment terms which are entered by closers may be quickly screened to identify proposed transactions which are out of bounds or which may require special approval prior to funding or completion.

As depicted in FIG. 3, process 200 may also include monitoring data entered associated with a deal to determine if the entered data represents a status change (depicted as process step 220). If the entry of data does involve a status change, a determination is made whether the status change involves a trigger event of some type (at 222). If so, any associated triggers or notifications are sent. A number of status changes may result in such trigger events or notificiations. For example, the following status changes may result in a trigger event causing a message to be communicated to selected individuals or entities:

When a debt deal or equity deal funding occurs (e.g., when a closer or other participant selects the “pre-funding” button associated with an investment (this may cause a message to be transmitted to selected individuals notifiying them of the occurance (the notification may be sent to different individuals based on the type of the deal, the geographical area of the deal, the size of the deal, etc.);

When a new investment is first entered, information regarding the new investment or deal may be communicated to selected individuals or entities;

When a new “legal entity” is entered associated with a deal, information regarding the new entity may be transmitted to selected individuals or entities (e.g., the legal department of the real estate investment entity may be notified of the new entity); and/or

When the status of a deal changes to “funded”, and if promotional materials are authorized, a “tombstone” notification may be sent to appropriate individuals directing them to publish the materials (and/or to review the materials prior to publishing if review is required).

Embodiments allow the specification and creation of a wide variety of trigger events and status changes which cause the trigger events. Further, in some embodiments, the closer or other participant entering new investment information may tailor or edit the nature of the trigger message which is to be transmitted. Different characteristics of each deal may cause the generation of different status events or triggers. For example, a real estate investment entity may require that different messages and different trigger events be transmitted depending on the geographical location of the subject property (e.g., to comport with local laws), the tax status of the investment (to comply with different regulatory and reporting requirements), or the like.

### EXEMPLARY USER INTERFACES

Reference is now made to FIGS. 4A-4B where several exemplary user interfaces are depicted. Each of the depicted user interfaces may be displayed on a display device of a computing device operated by a participant interacting with asset management system 22 to enter, view, edit, copy or otherwise utilize information regarding new investments associated with asset management system 22. For example, as depicted, the user interfaces are depicted as Web pages which may be viewed on a browser of a user device. Those skilled in the art will appreciate that these exemplary user interfaces may be presented in a variety of different formats.

The user interface depicted in FIG. 4A represents a main screen which may be accessed to begin entry of data regarding a new investment (or “deal”) (e.g., as descibed in steps 202-214 of FIG. 3). The user interface includes a number of tabs allowing the participant to enter information regarding the new deal, particular investments, properties, etc. Each tab may present a screen prompting the user to input information as described above in conjunction with FIG. 3.

The user interface depicted in FIG. 4B represents an exemplary screen which may be presented to a participant (such as a closer) prompting the participant to enter property information about properties associated with the new deal. A number of tabs are provided linking the page to other screens prompting the participant for other property-related information. Those skilled in the art will appreciate that similar screens may be presented to format and receive other data and information as described above in conjunction with the processes of FIGS. 2 and 3.

Although the present invention has been described with respect to a preferred embodiment thereof, those skilled in the art will note that various substitutions may be made to those embodiments described herein without departing from the spirit and scope of the present invention.

What is claimed is:

1. A method for establishing a real estate investment, comprising:
generating information identifying a potential real estate investment;
receiving information indicating that said potential real estate investment is a new investment;
transferring at least a portion of said information identifying said potential real estate investment to information identifying said new real estate investment; and
generating further information identifying said new investment, including information specifying at least one trigger event whose occurance results in at least one notification to a responsible party.

2. The method of claim 1, wherein said at least one trigger event is the completion of funding of said new investment.

3. The method of claim 1, wherein said trigger event is the entry of information identifying a new corporate entity associated with said new real estate investment.

4. The method of claim 2, wherein said trigger event results in notification to a legal department of a real estate investment entity.

5. The method of claim 1, wherein said at least one notification is transmitted via electronic mail to said responsible party.

6. The method of claim 2, wherein said trigger event results in notification to a marketing department of approval to publish a marketing release.

7. The method of claim 1, further comprising:
receiving information appointing a closer to manage said new investment.

8. The method of claim 7, wherein said closer is provided with data entry privileges allowing the closer to enter information identifying said new investment.

9. The method of claim 1, further comprising:
monitoring the entry of said information identifying said new investment to identify any changes causing the occurance of said at least one trigger event.

10. The method of claim 1, wherein said generating information identifying a potential real estate investment is performed under control of a first application.

11. The method of claim 10, wherein said generating information identifying said new real estate investment is performed under control of a second application, wherein said transferring at least a portion of said information identifying said potential real estate investment to information identifying said new real estate investment includes transferring information from said first application to said second application.

12. The method of claim 1, further comprising:
transferring said information identifying said new real estate investment to an asset management system upon completion of said new investment.

13. A method for establishing a real estate investment, comprising:
receiving information identifying a user responsible for a new real estate investment;
receiving, from said responsible user, information identifying said new real estate investment;
monitoring said received information identifying said new real estate investment for information triggering a trigger event; and
causing the transmission, when said triggering event is detected, of a notification message to a designated recipient.

14. The method of claim 13, wherein said information identifying said new real estate investment includes information identifying at least one of: a deal name; a type of transaction; a currency of the transaction; loan information; property information; and legal information.

15. The method of claim 13, wherein said information triggering said trigger event is information identifying that said new real estate investment is pre-funded.

16. The method of claim 13, wherein said information triggering said trigger event is information identifying the establishment of a new legal entity.

17. The method of claim 13, wherein said information triggering said trigger event is information identifying that said new real estate investment is funded.

18. The method of claim 15, wherein said notification message is an electronic mail message containing marketing information authorizing the publication of a tombstone announcement regarding said new real estate investment.

19. An apparatus for establishing a real estate investment, comprising:
a memory having at least one region for storing program code;
a processor for executing the program code stored in the memory to cause the apparatus to
receive information identifying a user responsible for a new real estate investment;
receive, from said responsible user, information identifying said new real estate investment;
monitor said received information identifying said new real estate investment for information triggering a trigger event; and
cause the transmission, when said triggering event is detected, of a notification message to a designated recipient.

20. A method, comprising:
storing first information identifying a potential investment;
identifying an approval to create a new investment from said potential investment;
updating said first information with second information identifying said new investment;
receiving information indicating that said new investment is completed; and
transferring said first and second information to an asset management system.
